(19) United States
(12) Patent Application Publication
(10) Pub. No.: US 2006/0143555 A1
(43) Pub. Date: Jun. 29, 2006

(54) Apparatus and method for extracting information from a formatted document

(75) Inventors: Xiaohong Huang, Chaoyan District (CN); Guowei Xu, Chaoyan District (CN)

Correspondence Address: STAAS & HALSEY LLP, SUITE 700, 1201 NEW YORK AVENUE, N.W., WASHINGTON, DC, 20005, US

(73) Assignee: FUJITSU LIMITED

(21) Appl. No.: 10/768,178

(22) Filed: Feb. 2, 2004

Related U.S. Application Data
(63) Continuation of application No. PCT/JP02/07983, filed on Aug. 5, 2002.

(30) Foreign Application Priority Data
Aug. 3, 2001 (CN) 01123845.3 (PAT.

(51) Int. Cl. G06F 17/21

(52) U.S. Cl. 715/500

(57) ABSTRACT

The present invention discloses an apparatus for extracting information from a formatted document, comprising: an input unit (1) for inputting a formatted document; a unit (2) for analyzing the input formatted document and saving the particular typographic information, a unit (3) for identifying special character strings on the basis of the analysis result by means of the typographic information such as font size, character font, color, etc.; a unit (4) for extracting the identified special character strings; and an output unit (5) for outputting the extracted character strings. When the typographic information of a certain character string is determined as a special typographic information, said character string is determined to be special character string. Thus, the present apparatus is able to automatically extract information from different types of format documents.

### CROSS-REFERENCE TO RELATED APPLICATIONS

This is a continuation of International Application PCT/JP02/07983, published in English, with an international filing date of Aug. 5, 2002, which claims priority to Chinese patent application 01123845.3, filed Aug. 3, 2001, both of which are herein incorporated by reference.

### TECHNICAL FIELD

The present invention in general relates to an apparatus and method for extracting information from an input formatted document, and in particular, to an apparatus and method for automatically extracting special character strings from an input formatted document, for example from web pages of online sale.

### BACKGROUND ART

It is known in the art an apparatus for extracting text information from a document, such as the technology disclosed in S. Soderland's article entitled of “Learning to Extract Text-base Information from the World Wide Web” (Proc. 3^{rd} Intl Conf. On Knowledge Discovery and Data Mining (KDD-97)). In such an apparatus, the special character strings are distinguished by means of the character strings being the function of attribute names (e.g. “goods names”) and placed before the special character strings, and are then extracted.

In the prior art apparatus, since the special character strings are distinguished and extracted by means of the character strings being the function of attribute names (such as “goods names”, etc.) and placed before the special character strings, it is effective when the attribute names such as “goods names” as well as the attribute values such as “monogram accessory pouch” are available. However, the documents such as the web pages of Internet have various formats. Therefore, there is a situation that the attribute names fail to be provided. For example, only the character strings “monogram accessory pouch” are provided. In the case that the attribute names are not provided, the special character strings can not be extracted by means of the above-mentioned technology. Moreover, in the present technology, the machine can not extract the special character strings automatically, if samples are not provided manually for the machine.

### SUMMARY OF THE INVENTION

To solve the above problems, the present invention is attained. Therefore, an object of the invention is to provide an apparatus and a method for automatically special character strings from an input formatted document.

In order to accomp1ish the object of the invention, there is provided an apparatus for extracting text information from an input formatted document, comprising: an input unit for inputting a formatted document; a unit for analyzing the input formatted document and saving the particular typographic information; a unit for identifying special character strings by means of the typographic information such as font size, character font, color, etc.; a unit for extracting the identified special character strings; and an output unit for outputting the extracted character strings.

According to another aspect of the invention, a method for extracting information from a formatted document is provided, which comprises the fol1owing steps: inputting a formatted document; analyzing the input formatted document and saving the particular typographic information; identifying special character strings by means of the typographic information such as font size, character font, color, etc.; extracting the identified specia1 character strings; and outputting the extracted character strings.

According to the invention, the operations of analyzing the input formatted document, identifying special character strings by means of the typographic information such as font size, character font, color, etc and extracting the special character strings enable to automatically extract special character strings from the input formatted document and considerably increase the accuracy of extraction. Moreover, the prior apparatus requires to manual1y input samples for memory, while the apparatus according to the invention can automatica1ly carry out the determination and extraction with respect to different types of the formatted document without inputting the samples.

### BRIEF DESCRIPTION OF THE DRAWINGS

FIG. 1 is a structural block chart of the apparatus for extracting information from a formatted document according to the invention.

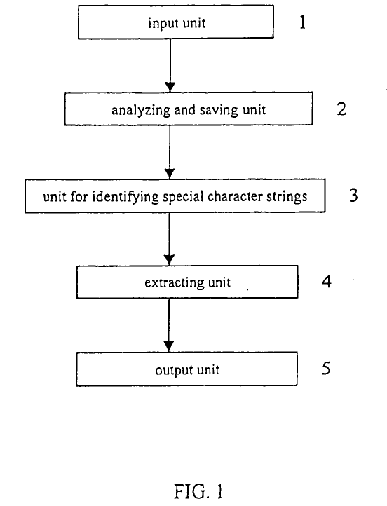

FIG. 2 is document data and a flowchart illustrating a first embodiment of the invention.

FIG. 3 document data and a flowchart illustrating a second embodiment of the invention.

FIG. 4 is document data and a flowchart illustrating a third embodiment of the invention.

FIG. 5 is document data and a flowchart illustrating a fourth embodiment of the invention.

### BEST MODE FOR CARRYING OUT THE INVENTION

As shown in FIG. I, there is a structural block chart of the apparatus for extracting information from a formatted document according to the invention.

In the extraction apparatus for extracting information from a formatted document as shown in FIG. I, numeral 1 indicates an input unit for inputting a formatted document; 2 indicates a unit for analyzing the input formatted document through a certain method and saving the particular typographic information, 3 is a unit for identifying special character strings on the basis of the analysis result by means of the typographic information such as font size, character font, color, etc., 5 is a unit for extracting the identified special character strings, and 5 is an output unit for outputting the extracted character strings.

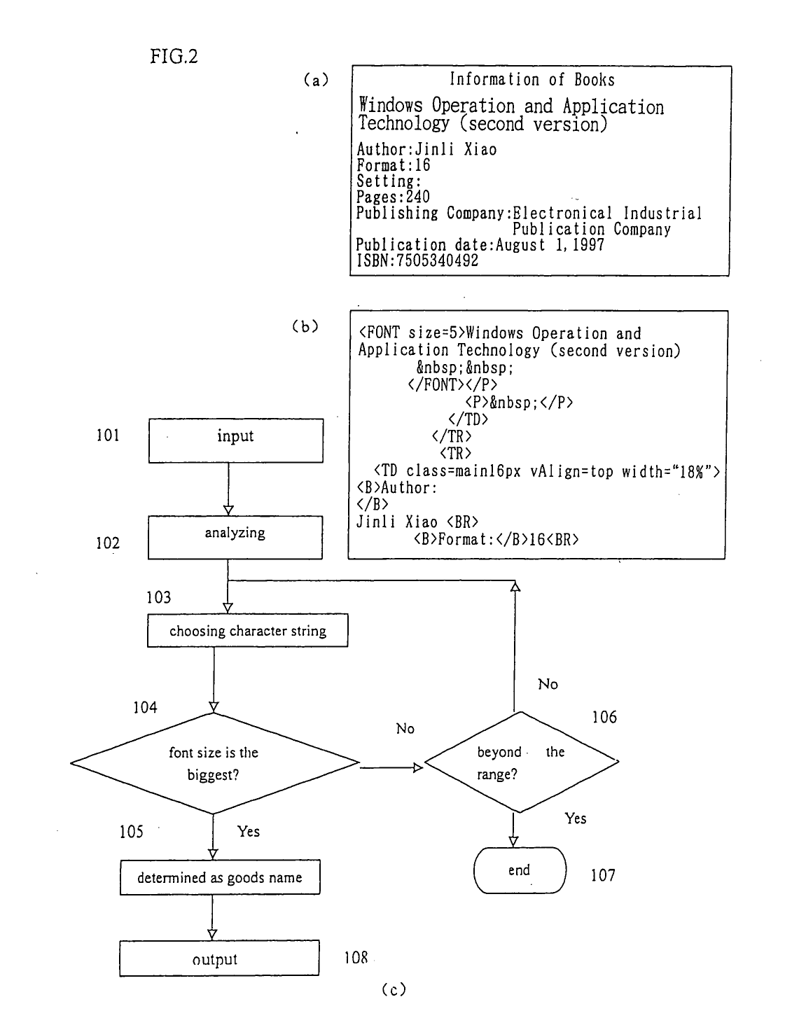

Next, the actions of the apparatus according to the invention will be described in detail with reference to FIGS. 2 to 5 by an example of extracting special character strings from HTML document.

### EXAMPLE 1

FIG. 2 is document data and a flowchart illustrating a first embodiment of the invention, wherein FIG. 2 (a) is sale information which are obtained from a certain network and are a document in the form of HTML, FIG. 2(b) is HTML source fi1e of the information shown in FIG. 2(a), FIG. 2(c) is a flowchart i1lustrating the actions of extracting information in example I.

Next, the flow of information extraction steps in example 1 is described as follows. In step I01, HTML source file as shown in FIG. 2 (b) is inputted. In step I02, the thus input HTML source file is analyzed so as to find typographic information. Then, in steps I03-I07, the special character strings are extracted.

At first, in step 103, the character strings to be discriminated are determined on the basis of the result obtained in step I02. Then, in step I04, a decision should be made on whether the font size of the character strings determined in step I03 is the biggest one with respect to the surrounding character strings. If it is not, then turns to the step I06. In step I06, a decision is made on whether the typographic information of said character strings is beyond the range of the preset values. If it is yes, then goes into step I07 in which the information extraction action is ended. If it is not, then returns to step I03 and thus determine the next character strings to be discriminated.

If the decision in step I04 is “yes”, that is, the typographic information of the character string “Windows Operation and Application Technology(second version)” in example 1 is (FONT size=5) and is the biggest among the surrounding character strings, it is determined as special typographic information. Then, goes into step I05, in which the character string “Windows Operation and Application Technology(second version)” is determined as special character strings, i.e., goods name.

Using the information extraction apparatus according to the present embodiment, the specia1 character string is enab1e to be automatically extracted from the input formatted document by discriminating it via typographic information such as font size.

### EXAMPLE 2

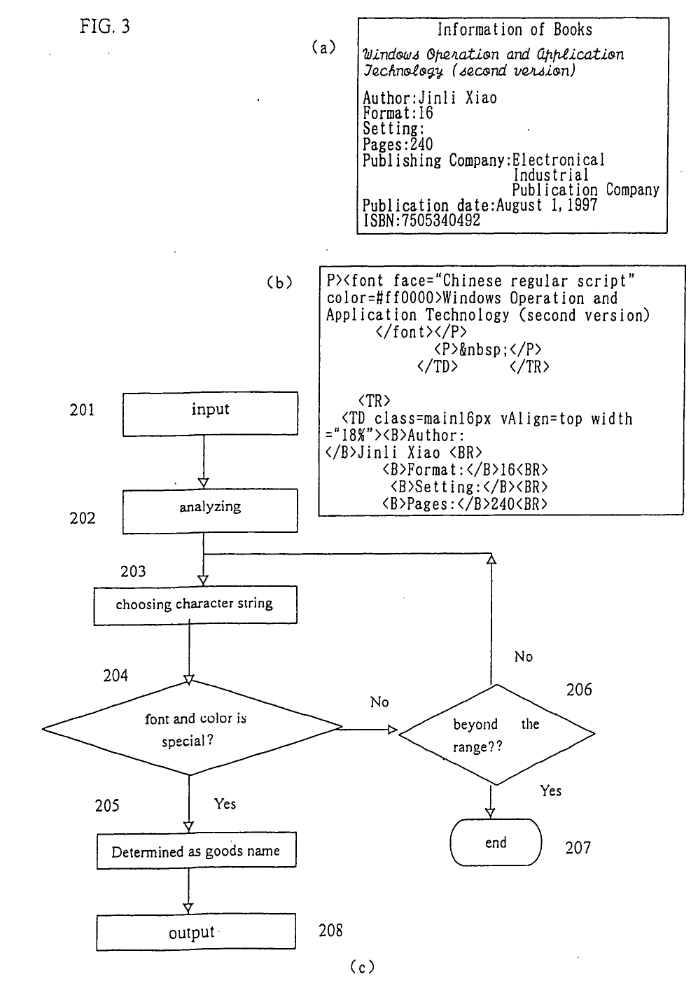

FIG. 3 is document data and a flowchart i1lustrating the second embodiment of the invention, wherein FIG. 3(a) is sale information which are obtained from a certain network and are a document in the form of HTML, FIG. 3(b) is HTML source file of the information shown in FIG. 3(a), FIG. 3(c) is a flowchart illustrating the actions of extracting information in example 2.

Next, the information extraction process in example 2 is described as follows. For clarity of illustration, the same steps as those described in the above example 1 are omitted, and only the different steps are described as below.

In step 204, a decision should be made on whether, for example, the font of the character string determined in step 203 is different from the surrounding character strings. If the decision in step 204 is “yes”, that is, the typographic information of the character string “Windows Operation and Application Technology(second version)” in example 2 is (FONT “Chinese regular script” and the color is red(color=# ff0000)) and is particularly different from the surrounding character strings, it is determined as special typographic information. Then, goes into step 205, in which the character string “Windows Operation and Application Technology(second version)” is discriminated as special character strings, i.e., goods name.

Using the information extraction apparatus according to the present embodiment, the special character string is enable to be automatically extracted from the input formatted document by discriminating it via typographic information such as font and color.

### EXAMPLE 3

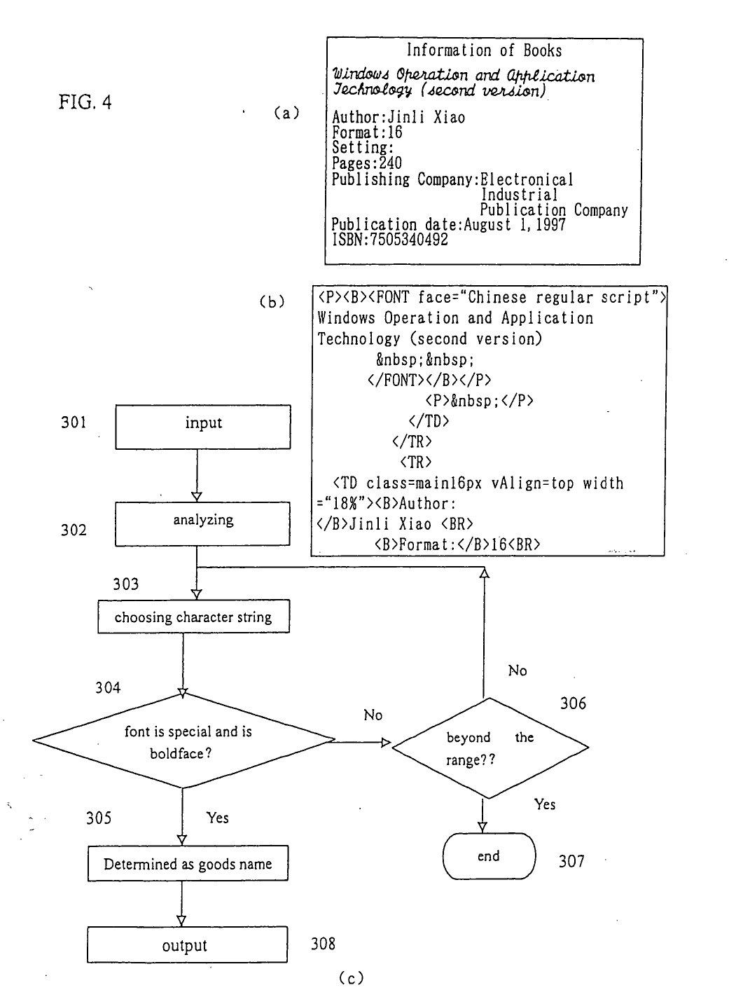

FIG. 4 is document data and a flowchart illustrating the third embodiment of the invention, wherein FIG. 4(a) is sale information which are obtained from a certain network and are a document in the form of HTML, FIG. 4(b) is HTML source file of the information shown in FIG. 4(a), FIG. 4(c) is a flowchart illustrating the actions of extracting information in example 3.

Next, information extraction process in example 3 is described in detail. For clarity of illustration, the same steps as those described in the above example 1 are omitted, and only the different steps are described as below.

In step 304, a decision should be made on whether, for example, the font of the character string determined in step 303 is different from the surrounding character strings. If the decision in step 304 is “yes”, that is, the typographic information of the character string “Windows Operation and Application Technology(second version)” in this example is (FONT “Chinese regular script” and boldface (<B><FONT . . . </B>)) and is particularly different from the surrounding character strings, it is determined as special typographic information. Then, goes into step 305, in which the character string “Windows Operation and Application Technology(second version)” is discriminated as special character strings, i.e., goods name.

Using the information extraction apparatus according to the present embodiment, the special character string is enable to be automatically extracted from the input formatted document by discriminating it via typographic information such as font and boldface.

### EXAMPLE 4

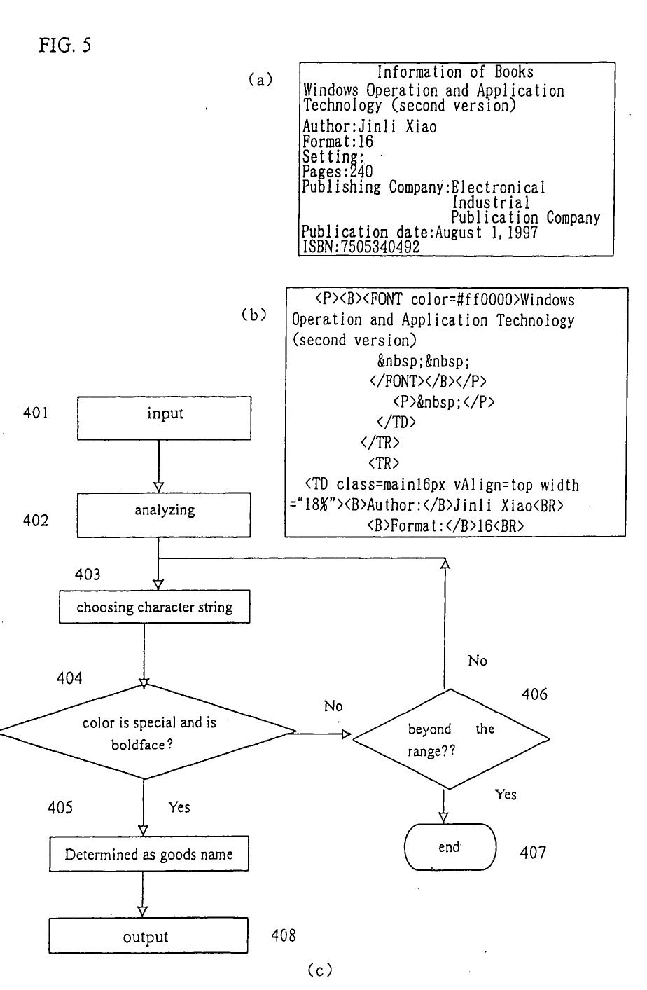

FIG. 5 is document data and a flowchart illustrating the fourth embodiment of the invention, wherein FIG. 5(a) is sale information which are obtained from a certain network and are a document in the form of HTML; FIG. 5(b) is HTML source file of the information shown in FIG. 5(a); FIG. 5(c) is a flowchart i1lustrating the actions of extracting information in example 4.

Next, information extraction process in example 4 is described in detail. For clarity of illustration, the same steps as those described in the above example 1 are omitted, and only the different steps are described as below.

In step 404, a decision should be made on whether, for example, the font of the character string determined in step 403 is different from the surrounding character strings. If the decision in step 404 is “yes”, that is, the typographic information of the character string “Windows Operation and Application Technology(second version)” in this example is (red color (color=#ff0000) and boldface) and is particular1y different from the surrounding character strings, it is determined as special typographic information. Then, goes into step 405, in which the character string “Windows Operation and Application Technology(second version)” is discriminated as special character strings, i.e., goods name.

Using the information extraction apparatus according to the this embodiment, the special character string is enable to be automatically extracted from the input formatted document by discriminating it via typographic information such as color and boldface.

It should be understood, however, that the above disclosure with respect to the examples 1-4 is il1ustrative only, other than any limitation to the present invention. Any modifications and variations to the embodiments I-4 of the invention may be made without departing from the spirit and the protection scope of the invention defined by the appended claims. For example, proper combination and variation of the embodiments I-4 can be made and can obtain the same effect of the invention, i.e., automatica1ly extracting special character strings.

1. An apparatus for extracting information from a formatted document, comprising: an input unit for inputting a formatted document; a unit for analyzing the input formatted document and saving the particular typographic information; a unit for identifying special character strings on the basis of the analysis result by means of the typographic information such as font size, character font, color, etc., a unit for extracting the identified special character strings; and an output unit for outputting the extracted character strings.

2. The apparatus for extracting information from a formatted document according to claim 1, wherein said unit for identifying specia1 character strings determines a certain character string as a special one on the basis of the typographic information of said formatted document when the typographic information of said character string is determined as a special typographic information.

3. The apparatus for extracting information from a formatted document according to claim 1, wherein said formatted document is HTML document, and said unit for identifying special character strings a certain character string as a special one on the basis of the analyzing results with respect to said HTML document when the font size of said character string is determined to be the biggest one among the surrounding character strings.

4. The apparatus for extracting information from a formatted document according to claim 1, wherein said formatted document is HTML document, and said unit for identifying special character strings determines a certain character string as a special one on the basis of the analyzing results with respect to said HTML document when the color and the font of said character string is determined to be a special one among the surrounding character strings.

5. The apparatus for extracting information from a formatted document according to claim 1, wherein said formatted document is HTML document, and said unit for identifying special character strings determines a certain character string as a special one on the basis of the analyzing results with respect to said HTML document when the font of said character string is determined to be different from the surrounding character strings and said character string to be boldface.

6. The apparatus for extracting information from a formatted document according to claim 1, wherein said formatted document is HTML document, and said unit for identifying special character strings determines a certain character string as a special one on the basis of the analyzing results with respect to said HTML document when the color of said character string is determined to be different from the surrounding character strings and said character string to be boldface.

7. A method for extracting information from a formatted document, comprising the following steps; inputting a formatted document, analyzing the input formatted document and saving the particular typographic information; identifying special character strings on the basis of the analysis result by means of the typographic information such as font size, character font, color, etc.; extracting the identified special character strings; and outputting the extracted character strings.

8. The method according to claim 8, wherein in the step of identifying special character string, a certain character string is determined as a special one on the basis of the typographic information of said formatted document when the typographic information of said character string is determined as a special typographic information.

9. The method according to claim 7, wherein said formatted document is HTML document, and in the step of identifying special character string, a certain character string is determined as a special one on the basis of the analyzing results with respect to said HTML document when the font size of said character string is determined to be the biggest one among the surrounding character strings.

10. The method according to claim 7, wherein said formatted document is HTML document, and in the step of identifying special character string, a certain character string is determined as a special one on the basis of the analyzing results with respect to said HTML document when the color and the font of said character string is determined to be a special one among the surrounding character strings.

11. The method according to claim 7, wherein said formatted document is HTML document, and in the step of identifying special character string, a certain character string is determined as a special one on the basis of the analyzing results with respect to said HTML document when the font of said character string is determined to be different from the surrounding character strings and said character string to be boldface.

12. The method according to claim 7, wherein said formatted document is HTML document, and in the step of identifying special character string, a certain character string is determined as a special one on the basis of the analyzing results with respect to said HTML document when the color of said character string is determined to be different from the surrounding character strings and said character string to be boldface.
